(19) United States
(12) Patent Application Publication
(10) Pub. No.: US 2024/0063554 A1
(43) Pub. Date: Feb. 22, 2024

(54) IMPROVING SCANNING TIME OF AN ANTENNA

(71) Applicant: SDEROTECH, INC., Kiryat Bialik (IL)

(72) Inventors: Rami Khair, Acre (IL); Dedi David Haziza, Kiryat Motzkin (IL)

(21) Appl. No.: 18/234,343

(22) Filed: Aug. 15, 2023

Related U.S. Application Data
(60) Provisional application No. 63/399,570, filed on Aug. 19, 2022.

(51) Int. Cl. H01Q 21/06; H01Q 1/46; H01Q 21/00; H01Q 1/48

(52) U.S. Cl. CPC H01Q 21/065; H01Q 1/46; H01Q 21/0087; H01Q 1/48

(57) ABSTRACT

An array antenna having radiating patches arranged in an array. Each of the radiating patches being connected to multiple variable phase shifters, wherein each phase shifter can produce a phase shift within a limited range. A switching arrangement is operable to connect different sets of variable phase shifters to the radiating patches to thereby scan the beam to desired directions.

### CROSS-REFERENCE TO RELATED APPLICATIONS

This application claims priority from U.S. Provisional Application No. 63/399,570, filed Aug. 19, 2022, the disclosure of which is incorporated herein by reference in its entirety.

### BACKGROUND

### 1. Field

The subject disclosure relates to improvements in response time of scanning array antenna, especially beneficial when used in conjunction of electronic devices, such as, e.g., variable dielectric constant antenna.

### 2. Related Art

The subject inventor has previously disclosed designs of array antennas which utilize variable dielectric constant (VDC) materials to enable software control of the antenna. See, e.g., U.S. Pat. Nos. 10,505,280 and 10,686,257, which are incorporated herein by reference in their entirety. As explained in these patents, when an appropriate electrical field is applied, the molecules rotate an amount that correlates with the strength of the applied field, and when the field is removed the molecules return to their relaxed state, thus changing the dielectric constant and affecting the transmission of an RF signal traveling in proximity to the molecules. However, the temporal response to application of the field, i.e., Tᵣᵢₛₑ or aligning the domains, is much faster than the temporal response to turning off the field, i.e., T_{fall} or relaxing the domains. That is, Tᵣᵢₛₑ and T_{fall} are inherently asymmetrical. Tᵣᵢₛₑ is controlled by the potential applied across the VDC, while T_{fall} is controlled by the relaxation time of the VDC when the potential is removed. Hence, T_{fall} is inherent property of the VDC material, which drastically slows the reaction time of the antenna. In certain applications, such as those disclosed by the subject inventor in the above cited patents and in U.S. Pat. Nos. 7,466,269, 7,884,766 and 10,199,710, which are incorporated herein by reference, it is highly desirable to have the turn off response at speeds similar to the turn on response.

### SUMMARY

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Disclosed embodiments overcome the inherent asymmetry in the Tᵣᵢₛₑ and T_{fall} times by changing the control of the domain, such that changes in the dielectric constant is caused mostly using application of potential, and minimizing reliance on natural relaxation. For example, when the VDC is used for phase shifting in a scanning array antenna, each phase shifter is activated as much as possible on its Tᵣᵢₛₑ slope, which is much faster than the T_{fall} slope, and hence the overall antenna response time is improved. Thus, rather than following attempts to increase the speed of T_{fall}, the inventors' innovations circumvent or minimizes the reliance on T_{fall} when scanning the beam.

In disclosed embodiments, multiple variable phase shifters are coupled to each radiating element. Each of the variable phase shifters is programmed to operate within a sub-band of the total shift band for the radiating element. The amount of required phase shift at each given instance is transmitted by the controller (e.g., a FPGA) and a switch, such as a multiplexer, determines which of the phase shifter should be activated to achieve the desired shift. By calculated selection, each instruction from the controller can be translated by the multiplexer to cause a phase shift that relies on Tᵣᵢₛₑ, rather than on T_{fall}.

Disclosed embodiments provide an antenna, comprising: a plurality of radiators arranged in an array; a plurality of transmission lines, each coupled to one of the radiators; a plurality of variable phase shifters divided into a plurality of subgroups, each of the subgroups interposed between one of the transmission lines and one of the radiators; a controller outputting a signal indicative of amount of phase shift to be activated for each of the radiators; a switch interposed between the transmission lines and the plurality of variable phase shifters, the switch receiving the signal from the controller and connecting selected variable phase shifters to selected transmission lines according to the signal.

By the embodiments disclosed herein, an array antenna is provided, comprising: a variable dielectric constant (VDC) plate; a plurality of radiating patches provided in an array over the VDC plate; a plurality of variable delay lines provided over the VDC plate and below the radiating patches; a plurality of fixed delay lines provided over the VDC plate and below the radiating patches, each fixed delay line connected to one of the variable delay lines; a corporate feed having a plurality of ports; a ground plane; and a plurality of switches configured to selectively connect each of the ports to a selected variable delay line and to selectively connect each of the radiating patches to a selected fixed delay line. The antenna may have m fixed delay line, wherein n of the fixed delay lines introduce zero delay, and wherein n<m. The antenna may have m variable delay lines and n fixed delay lines, wherein n<m. Each of the switches may have one port and at least two throws. In the antenna, the variable delay lines may be provided on one layer and the fixed delay lines may be provided on a second layer above the first layer. Alternatively, the variable delay lines and the fixed delay lines may be provided on the same layer.

### BRIEF DESCRIPTION OF THE DRAWINGS

Other aspects and features of the invention would be apparent from the detailed description, which is made with reference to the following drawings. It should be appreciated that the detailed description and the drawings provides various non-limiting examples of various embodiments of the invention, which is defined by the appended claims.

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a general schematic of an antenna array which may incorporate any of the embodiments disclosed herein.

FIG. 2 illustrates an embodiment utilizing two variable phase shifters having overlapping shift sectors.

FIG. 2A illustrates an embodiment for a switching arrangement for a dual variable phase shifters as exemplified in FIG. 2.

FIG. 3 is a schematic diagram illustrating an example of four variable phase shifters for one radiator in an array.

FIG. 3A is a plot illustrating an example of how the embodiment of FIG. 3 reduces the time to achieve phase changes.

FIG. 3B illustrates an embodiment for a switching arrangement for four variable phase shifters radiating element, as exemplified in FIG. 3.

FIG. 4A is a plot of time Tᵣᵢₛₑ to achieve phase change up to 90°, while FIG. 4B is a plot showing relaxation time T_{fall} of phase shift returning to zero for a Ku band antenna.

FIG. 5 illustrates a schematic of another embodiment utilizing four variable phase shifters, while FIG. 5A illustrates a plot of random phase changes achieved by a conventional variable phase shifter and the innovative variable phase shifter of FIG. 5.

FIG. 6 illustrates an example of four variable phase shifter having overlapping sectors.

FIG. 7A illustrates an example of a variable phase shift (VPS) layer, while FIG. 7B illustrates an example of a fixed phase bias (FPB) layer.

FIG. 8 is a cross-section of a section of an antenna array showing one of the radiating patches, in an embodiment implementing two variable phase shifters per radiating element.

### DETAILED DESCRIPTION

Embodiments of the inventive system and method for improving response time of variable dielectric constant antenna will now be described with reference to the drawings. Different embodiments or their combinations may be used for different applications or to achieve different benefits. Depending on the outcome sought to be achieved, different features disclosed herein may be utilized partially or to their fullest, alone or in combination with other features, balancing advantages with requirements and constraints. Therefore, certain benefits will be highlighted with reference to different embodiments, but are not limited to the disclosed embodiments. That is, the features disclosed herein are not limited to the embodiment within which they are described, but may be “mixed and matched” with other features and incorporated in other embodiments.

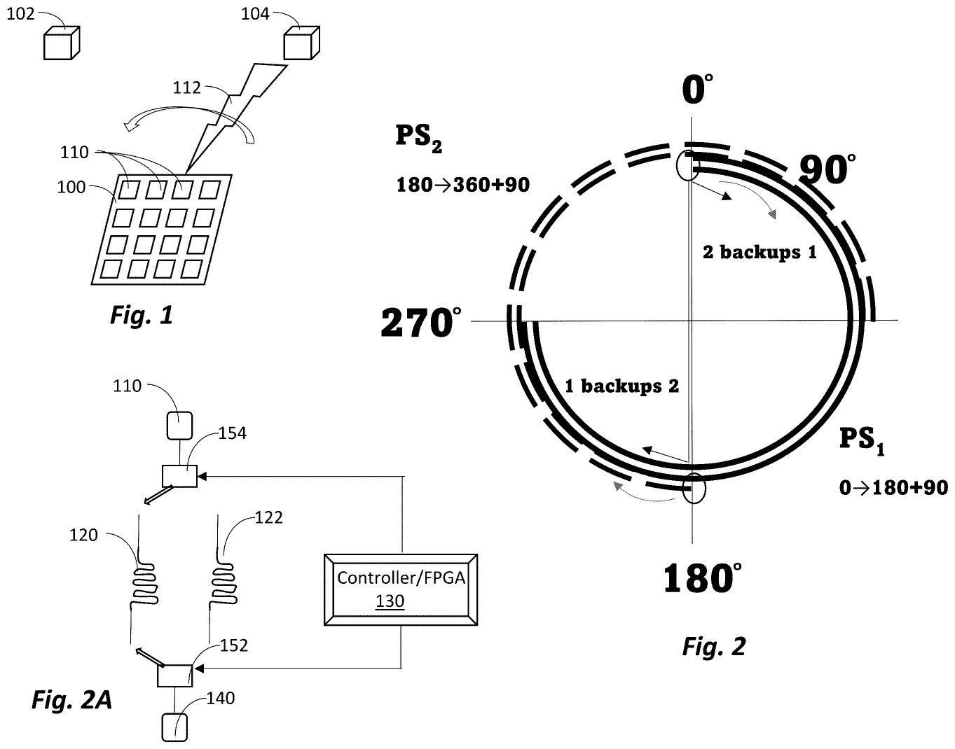

FIG. 1 is a general schematic of an array antenna 100 made up of multiple radiators 110, which together form a single beam 112 of the array antenna 100. By controlling the phase of each radiator 110 in the array, the beam 112 of the antenna 100 can be shaped and steered. For example, the beam can be aimed for communication with either satellite 102 or satellite 104. The beam may also be steered so as to keep with the motion of either satellite in the sky, or can be steered to jump from one satellite to the other, e.g., when one satellite moved out of line of sight. In this respect, it should be appreciated that a jump from one satellite to the next may cause an interruption in communication until the next satellite is acquired and communication established. Therefore, the speed of steering the beam is paramount in reducing the communication interruption. Thus, the fastest the required phase of each radiator can be established, the faster the steering control and the shorter the communication interruption.

As explained above and in the above-cited patents, control of the phase of each radiator is done by changing the dielectric constant of the VDC by application of appropriate potential, generally a DC voltage. However, while a phase change that requires increased potential can be achieved relatively fast, a phase change that requires reduced potential is relatively slower, since the VDC domains must relax naturally. This problem is solved using the invention disclosed herein, which is exemplified by the following embodiment.

In conventional antenna array, the phase of each radiator is controlled by a single phase shifter. Conversely, according to disclosed embodiments, the phase of each radiator is controlled by multiple variable phase shifters, each variable phase shifter being tailored to operate within a dedicated phase shift range. In its most simplistic form, each radiator is switchably coupled to two variable phase shifters, a first phase shifter operable for phase shift in the range of 0°-80°, and a second phase shifter operable for phase shift of 180°-360°. Thus, for any phase shift between 0°-80°, e.g., 75°, the appropriate potential is applied to the first phase shifter and a switch is operated to connect the first phase shifter to the radiator. Conversely, for any phase shift between 180°-360°, e.g., 175°, the appropriate potential is applied to the second phase shifter and the switch is operated to connect the second phase shifter to the radiator. Of course, any number of phase shifters can be used, and the more phase shifters are used the faster the scanning of the beam can be achieved.

FIG. 2 illustrates an embodiment utilizing two variable phase shifters having overlapping sectors. In the embodiment of FIG. 2, each variable phase shifter introduces a phase shift of less than 360°, specifically, in the case of FIG. 2 each variable phase shifter introduces a phase shift of 270°. Phase shifter PS1 introduces a phase shift extending from 0° to 270°, as shown in solid double-line, while variable phase shifter PS2 introduces a phase shift extending from 180° to 90°, as shown in dashed double-line. In this regard, it can be thought of as PS1 introduces a phase shift from 0° to 180° with an extension of 90°, while PS2 introduces a phase shift from 180° to 360° with an extension of 90°. Therefore, this arrangement results in two 90° sectors that can be covered by either phase shifter, and two 90° sectors that are covered by only one phase shifter. Therefore, the possibility that a phase change would have to be achieved by relaxation is reduced by half.

To illustrate, in the example of FIG. 2, say the phase is held at 89° by PS1 and it needs to be changed to 20°. Rather than changing the power on PS1, causing the domain to relax naturally to 20°, PS2 is energized to 20° and is connected, while PS1 is disconnected. Similarly, say the phase is held at 260° by PS2 and it needs to be changed to 182°. Rather than changing the power on PS2, causing the domain to relax naturally, PS1 is energized to 182° and is connected, while PS2 is disconnected. So, movements in the sectors 0°-90° and 180°-270° never rely on domain relaxation, but can always utilize Tᵣᵢₛₑ. Conversely, in the sectors 90°-180° and 270°-360° increase in phase angle is done using Tᵣᵢₛₑ, while decrease in phase angle is done via domain relaxation, i.e., T_{fall}. Consequently, all phase angle changes rely on fast Tᵣᵢₛₑ, except for decrease in phase angle in the sectors 90°-180° and 270°-360°, which are controlled by slower T_{fall}.

In general terms, the antenna has a plurality of variable phase shifters arranged as plurality of subgroups of variable phase shifters, each subgroup including n variable phase shifters, and each variable phase shifter within the group introduces a phase shift of up to 360°/n, wherein n is a number greater than 1. However, in embodiments employing overlap, each variable phase shifter within the group introduces a phase shift of up to (360°/n)+m, wherein m<(360°/n). For example, when n=2, m is smaller than 180°, and if m=90°, as shown in FIG. 2, then each variable phase shifter can introduce a phase shift of up to (360°/2)+90°=270°.

FIG. 2A illustrates an embodiment for a switching arrangement for a dual variable phase shifters as exemplified in FIG. 2. For clarity, FIG. 2A illustrates the switching arrangement for a single radiating element 110, but the arrangement is replicated for each of the radiating elements 110 in the array antenna. Port 140 receives the RF signal, e.g., an RF port of a corporate feed. The variable phase shifters 120 and 122 are inserted into the circuit using a dual switching arrangement—one at the radiating element side and one at the RF port side. RF switch 152, e.g., a pin diode or an SPDT (single port dual-throw) switch selectively connects either of variable phase shifters 120 or 122 to the RF port 140, while RF switch 154, e.g., a pin diode or an SPDT switch selectively connects either of variable phase shifters 120 or 122 to the radiating element 110. Switches 152 and 154 are controlled by controller 130 to ensure selection of one of the variable shifters 120 or 122 to the RF circuit path.

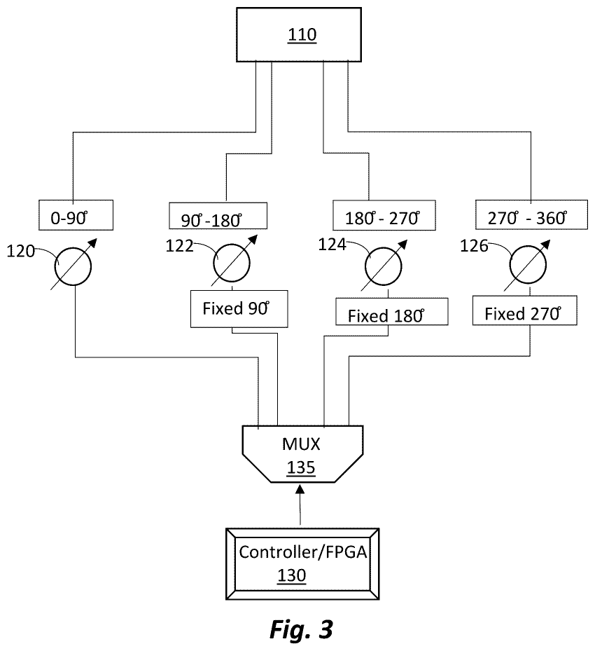

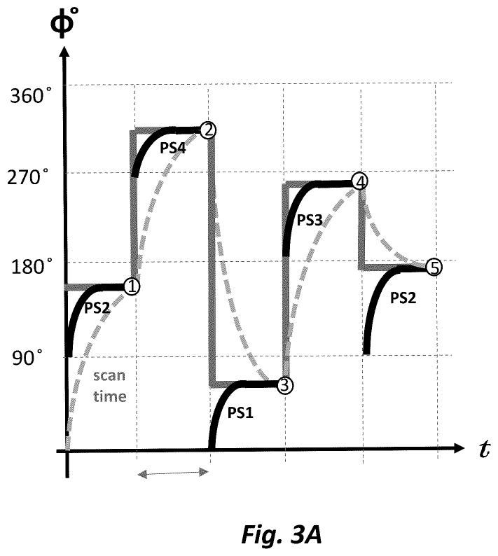

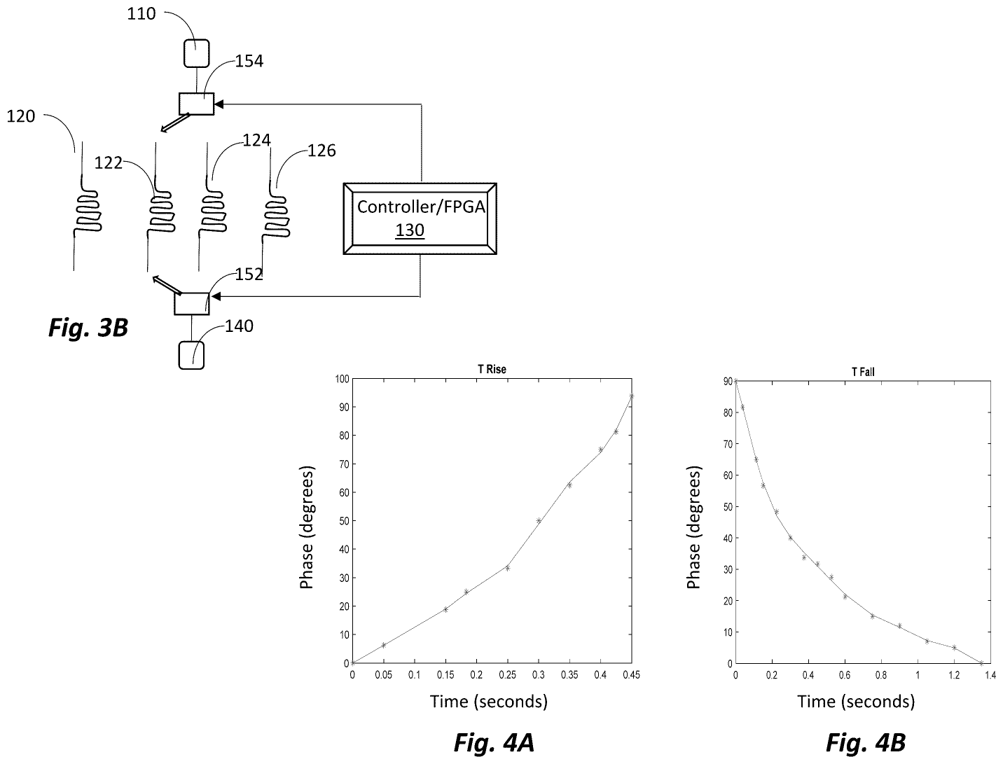

FIG. 3 is a schematic diagram illustrating an example of four variable phase shifters for one radiator 110, such that each variable phase shifter is configured to operate within a 90° range. Of course, this arrangement is replicated for each radiator in the array. In this example, variable phase shifter 120 is operable for phase shifts in the range 0°-90°, variable phase shifter 122 is operable for phase shifts in the range 90°-180°, variable phase shifter 124 is operable for phase shifts in the range 180°-270°, and variable phase shifter 126 is operable for phase shifts in the range 270°-360°. The controller 130 sends a signal for the appropriate phase shift to be applied to each radiator, and that signal is used by the multiplexer (or switch) to determine to which of the variable phase shifter to route the transmission through so that the change of phase shift from the previous phase shift is the smallest and is driven by applied potential, rather than domain relaxation.

In the example of FIG. 3, variable phase shifter 120 operates to impart phase shift of 0°-90° only. Therefore, it may be made much shorter than a phase shifter that is required to perform up to 360° phase shift. Consequently, the insertion loss is also much lower. For example, a 3 db insertion loss of a 0°-360° phase shifter is reduced to about 0.8 db for the 0°-90° phase shifter. The other phase shifters are made to be the same length as phase shifter 120, thereby each generating a 90° phase shift. In this example, in order to change the range of each variable phase shifter, a static phase shifter is inserted in the lines of the three variable phase shifters: a 90° fixed phase shifter in the line of variable phase shifter 122, a 180° fixed phase shifter in the line of variable phase shifter 124, and a 270° fixed phase shifter in the line of variable phase shifter 126. In this manner, all of the variable phase shifters on the antenna have the same structure and operates using the same voltage potential, but operates at a different range of phase shifts.

The fixed phase shifter does not rely on the VDC layer to generate the phase shift, so that Tᵣᵢₛₑ and T_{fall} do not apply to the fixed phase shifters. The fixed phase shifters may be made by, e.g., inserting a dielectric slab or ferrite in the transmission line. The dielectric constant and signal travel length within the fixed phase shifter are selected to generate the desired fixed phase shift. Using such a structure the fixed phase shifter is a passive device and operates independently of the VDC layer. The fixed phase shifters may be any off-the-shelf devices or may be formed integrally within the layers of the array antenna.

FIG. 3A is a plot illustrating an example of how the embodiment of FIG. 3 reduces the time to achieve phase changes. In FIG. 3A the abscissa denotes time (e.g., in seconds) and the ordinate denotes the phase angle (in degrees). The solid curves indicate operation of the phase shifters of FIG. 3, while the dashed curves indicate operation of a conventional single variable phase shifter operating in the range 0°-360°. Point 1 seems to be at about 160°. Thus, in order to generate the delay of point 1 using traditional system, the variable phase shifter needs to be operational for a sufficient time Tᵣᵢₛₑ to go from 0° to 160°. Conversely, using the system of FIG. 3, phase shifter 122 (i.e., PS2) only needs to be operational for sufficient time Tᵣᵢₛₑ to go from 90° to 160°, which is much faster. Similarly, to reach point 2, at about 300°, the conventional phase shifter operates for Tᵣᵢₛₑ to go from 160° to 300°. Conversely, using the system of FIG. 3, variable phase shifter 126 (i.e., PS4) only needs Tᵣᵢₛₑ to go from 270° to 300°. Importantly, in order to go to point 3 at 70°, the conventional variable phase shifter needs to reduce potential and rely on a long T_{fall} to reach 70°. Conversely, utilizing the system of FIG. 3 variable phase shifter 120 (i.e., PS1) is operated for a short time Tᵣᵢₛₑ to reach 70°. Thus, as can be seen in the example plot of FIG. 3A, in addition to shortening the time Tᵣᵢₛₑ required to increase phase shifts, the embodiment of FIG. 3 also obviates the need to rely on T_{fall} and replaces it with Tᵣᵢₛₑ, which is much faster.

FIG. 4A is a plot of time Tᵣᵢₛₑ to achieve phase change up to 90°, while FIG. 4B is a plot showing relaxation time T_{fall} of phase shift returning to zero. This case is for a Ku band antenna. FIG. 4A shows that the maximum time for a 90° phase shifter is 0.45 seconds going from zero to 90°. Since all of the variable phase shifters of FIG. 3 operate only over 0°-90°, the maximum time to achieve any Tᵣᵢₛₑ-based phase angle using the system of FIG. 3 would be 0.45 seconds. Conversely, utilizing a conventional variable phase shifter that covers 0°-360°, the time for maximum Tᵣᵢₛₑ-based phase shift would be at least four times longer. Moreover, since in the system of FIG. 3 any phase can be achieved using Tᵣᵢₛₑ, any reduction in phase angle that is done by activating another phase shifter would also take a maximum of 0.45 seconds. Conversely, a conventional variable phase shifter would have to rely on domain relaxation which, as shown in FIG. 4B, even for 90° change would take three time longer.

FIG. 3B illustrates an embodiment for a switching arrangement for four variable phase shifters per one radiating element, as exemplified in FIG. 3. For clarity, FIG. 3B illustrates the switching arrangement for a single radiating element 110, but the arrangement is replicated for each of the radiating elements in the array antenna. This arrangement is similar to that shown in FIG. 2A, except that switches 152 and 154 may be, e.g., SP4T (single port four-throw) RF switches. As explained above, variable phase shifters 122, 124 and 126 would include a fixed phase shifter in order to define the operational range of these variable shifters.

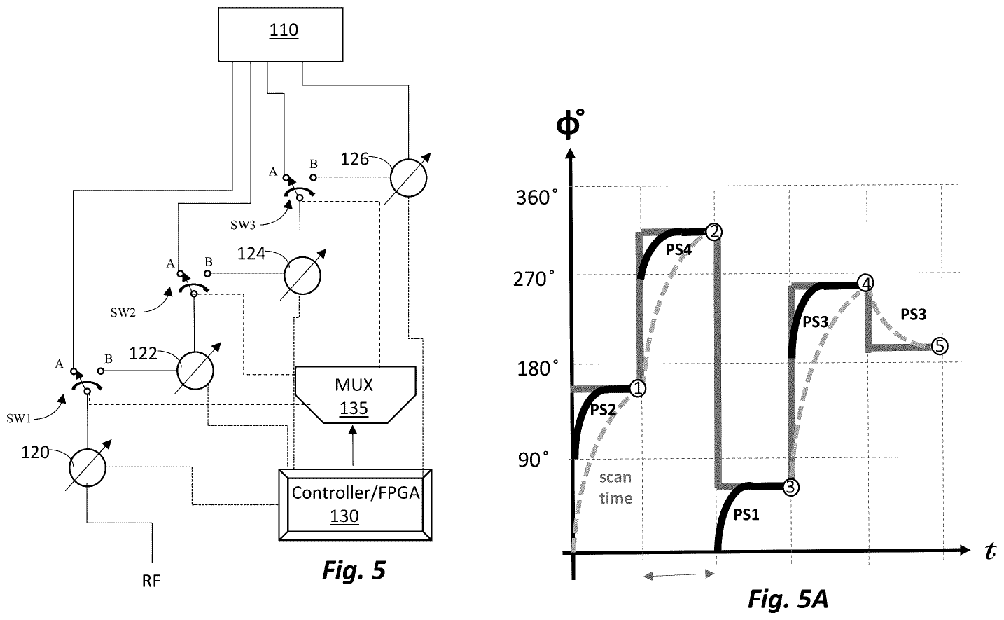

FIG. 5 illustrates a schematic of another embodiment utilizing four variable phase shifters. In this embodiment each of variable phase shifters 120, 122, 124 and 126 has a range of 90°. No fixed phase shifters are incorporated in this embodiment, yet each variable phase shifter is made to operate in one dedicated phase range. Three switches SW1, SW2, and SW3 are illustrated in FIG. 5, but they may be internal to the MUX 135, except that for better understanding they are illustrated individually with dash lines as control lines from the MUX 135. Also, the dotted lines illustrate control signal from the controller 130. When switch SW1 is in the A position, the signal from the variable phase shifter 120 proceeds directly to the radiator 110. The controller may provide signals to the variable phase shifter 120 to generate a phase shift of between 0° and 90°. When switch SW1 is in the B position, the signal from the variable phase shifter 120 is routed through the variable phase shifter 122. At this position the controller can provide a signal to the variable phase shifters 120 and 122 to each generate a phase shift of between 0° and 90°. However, since the signal passes through both variable phase shifters, the phase shifts are added, so that the resulting phase shift leaving variable phase shifter 122 is between 0° and 180°. If switch SW2 is in the A position, that phase shifted signal is delivered to the radiating element 110. Conversely, when switch SW2 is in the B position, the controller can provide a signal to the variable phase shifter 124 to generate a phase shift of between 0° and 90°. That phase shift is added to the combined phase shift of variable phase shifters 120 and 122. If switch SW3 is in the A position, the signal is provided to the radiating element 110, while if it is in the B position, it will be added to the phase shift generated by variable phase shifter 126, which is also between 0° and 90°. Therefore, the operation and resulting phase shifts is similar to that of the embodiment of FIG. 3, and the benefits shown in FIG. 3A are equally applicable to this embodiment, as illustrated by the plot of FIG. 5A.

To illustrate, to generate a 175° phase delay in the signal using the embodiment of FIG. 5, phase shifter 120 is energize to maximum potential to generate a 90° phase change. The switch SW1 is set to the B throw so the signal proceeds to variable phase shifter 122. Phase shifter 122 is energized to cause a phase change of 85° and switch SW2 is set to the A throw. Consequently, the signal delivered to radiating patch 110 is shifter 175°. If the next phase shift is to be 85°, the conventional system would have T_{fall} for relaxation from 175° to 85°. Conversely, in the system of FIG. 5 SW2 is switched to Throw A and relaxation only needs to take from 90° to 85°, making the transition much faster.

FIG. 5A illustrates a plot of random phase changes achieved by a conventional variable phase shifter and the innovative variable phase shifter of FIG. 3 or 5. As with the explanation regarding the plot of FIG. 3A, for points 1, 2, 3, and 4, the embodiment of FIG. 5 achieves the desired phase change much faster than the convention shifter. However, when the phase shift required is within the same operational range of the current phase shift, the systems as shown in FIG. 3 or 5 revert to utilizing domain relaxation of longer time T_{fall}. For example, the phase shift of point 4 is within the operational range of phase shifter PS3, but the next phase shift of point 5 is also within the operational range of phase shifter PS3. Thus, achieving this phase change would take as much time with the embodiments of FIG. 3 or 5 as the conventional shifter.

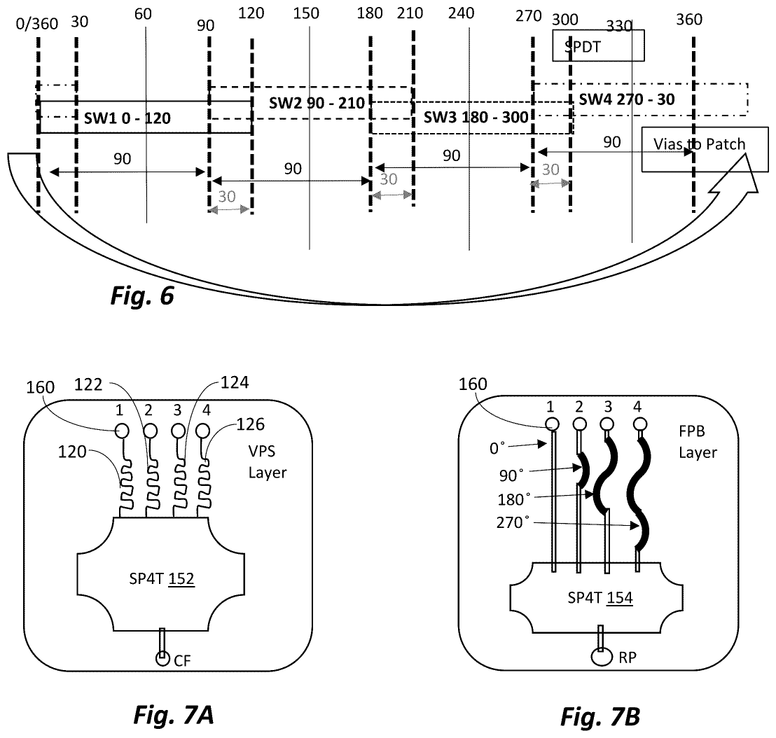

A partial solution to minimize the need to rely on T_{fall} in the embodiment of FIGS. 3 and 5 is to implement overlap as shown with the embodiment of FIG. 2. For example, instead of each of the variable phase shifters of FIG. 3 or 5 be designed for a range of 90°, it can be made to operate over a range of 120°. Such an example is depicted in FIG. 6. In this example, SW1 operates at a range of 0°-120°, SW2 operates at the range of 90°-210°, SW3 operates over the range of 180°-300° and SW4 operates at the range of 270°-30°. Consequently, SW1 overlaps with SW2 over the range of 90° 420°, SW2 overlaps SW3 over the range of 180°-210°, SW3 overlaps SW4 over the range of 270°-300° and SW4 overlaps SW over the range of 0°-30°. This arrangement reduces the exposure of the system to potential use of domain relaxation and T_{fall}.

Also, if the next desired phase is within an overlap, an algorithm can be developed to determine whether to just utilize the T_{fall} of the current shifter or activate the overlapping phase shifter, in order to minimize the time it takes to reach the next phase shift. For example, the change in phase may be so small that letting the domain relax may be faster than activating the overlapping shifter and utilizing Tᵣᵢₛₑ. For example, the decision can be made based on time comparison of T_{fall} of the current shifter versus Tᵣᵢₛₑ of the overlapping shifter:
If (Tᵣᵢₛₑ(ϕₒ→Ω₂)>T_{fall}(Ω₁→Ω₂)), then activate overlap shifter;
wherein Ω₁ is the current phase, Ω₂ is the next desired phase and ϕₒ is the current phase of the overlapping shifter (presumably zero, at least for the embodiment of FIG. 3).

According to another example, the decision can be made based on minimizing phase distance. In this specific example, it is assumed that Tᵣᵢₛₑ is three time as fast as T_{fall}, but an accurate multiplier can be derived experimentally for different implementations. Taking the distance from the current phase to the desired phase using the current phase shifter as (Name PS, taking the and distance from the current phase to the desired phase using the overlap phase shifter as φ_{bk_PS}, the decision to revert to the overlapping (backup) phase shifter could be made by considering:
If Ø_{bk_PS}≤3·Øsame_{PS} Then backup=True

As disclosed in, e.g., the above cited U.S. Pat. Nos. 10,505,280 and 10,686,257, embodiment of the array antenna can be fabricated using multiple layers, wherein each layer is dedicated to a certain function, e.g., radiating layer, phase shift layer, variable dielectric layer, ground/common layer, etc. Therefore, in various embodiments implementing the multiple phase shifters per radiating element, the required tasks can be relegated to different layers in the stack. FIGS. 7A and 7B illustrate embodiments of two layers for an antenna using four variable phase shifters per radiating element, e.g., such as the example shown in FIG. 3. FIG. 7A illustrates an example of a variable phase shift (VPS) layer, while FIG. 7B illustrates an example of a fixed phase bias (FPB) layer. The vias 160 pass the transmission signals between the two layers, wherein VPS layer is below FPB layer. FIG. 7A illustrates the switch SP4T 152 interposed between the corporate feed port CF and the four variable phase shifters 102, 122, 124 and 126. Each of the four variable phase shifters 102, 122, 124 and 126 can generate a phase shift of 0°-90°. FIG. 7B illustrates the switch SP4T 154 interposed between the radiator patch via RP and four transmission lines, three of which incorporating a fixed phase shifter of 90°, 180° and 270°, respectively, thus the signal on line 1 would be shifted 0°-90°, the signal on line 2 would be shifted 0°-90°+90°, the signal on line 3 would be shifted 0°-90°+180°, the signal on line 4 would be shifted 0°-90°+270°. As described with respect to FIG. 6, the variable phase shifters may be formed to generate a phase shift of different range, e.g., 0°-120°, so as to enable overlap between successive phase shifters. Also, in this context, the four lines can be thought of as four fixed phase shifters, wherein one of the lines introduces zero phase shift, one introduces 90° phase shift, one introduces 180° phase shift, and one introduces 270° phase shift. In one example, all of the fixed phase shifters are conductive lines of different lengths designed to introduce the desired fixed phase shift. For example, if one line has length that is exact multiple of the wavelength and a second line is longer by a quarter of a wavelength, then the first line will introduce zero phase shift and the second line will introduce a 90° phase shift.

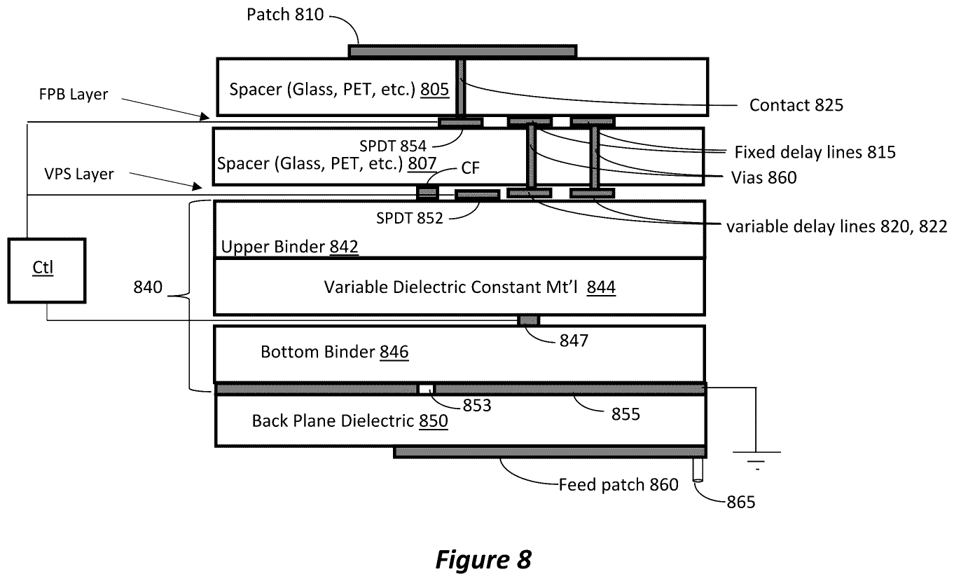

FIG. 8 is a cross-section of a section of an antenna array showing one of the radiating patches, in an embodiment implementing two variable phase shifters per radiating element. While relevant explanation of the elements of FIG. 8 will be provided herein, for better understanding the reader should review the above-cited patents which provide more detailed explanation of the structure and function of the different layers and possible variations. In the embodiment of FIG. 8, the fixed phase bias layer is provided over the variable phase shift layer, as in the embodiments of FIGS. 7A and 7B.

Referring to FIG. 8, a top dielectric spacer 305 is generally in the form of a dielectric (insulating) plate or a dielectric sheet, and may be made of, e.g., glass, PET, etc. The radiating patch 810 is formed over the spacer by, e.g., adhering a conductive film, sputtering, printing, etc. At each patch location, a via is formed in the dielectric spacer 805 and is filled with conductive material, e.g., copper, to form contact 825, which connects physically and electrically to radiating patch 810. The switch, in this example an SPDT 854 is connected at the port to the contact 825 and at the double-throw to either one of fixed delay lines 815, forming two fixed phase shifters (one of which may introduce zero phase shift). The fixed delay line 815 are formed on the bottom surface of dielectric spacer 805 or on top surface of dielectric spacer 807. Each of the delay lines 815 may be formed as a meandering conductive line and may take on any shape so as to have sufficient length to generate the desired delay, thereby causing the desired fixed phase shift in the RF signal.

Vias 860 are formed in the dielectric spacer 807 and connect to variable delay lines 820 and 822, such that each of the variable delay lines 820 and 822 is electrically connected to one of the fixed delay lines 815. The switch, in this example SPDT 852 connects one of the variable delay lines 820 or 822 to port CF. Consequently, a signal traveling through variable delay line 820 experiences the variable delay introduced by variable delay line 820 and its corresponding fixed delay line 815 (e.g., 0°), while a signal traveling in variable delay line 822 experiences the variable delay introduced by variable delay line 822 and the fixed delay introduced by the respective fixed delay line 815 (e.g., 180°).

The delay in the variable delay lines 820 and 822 may be controlled by the variable dielectric constant (VDC) plate 840 having variable dielectric constant material 844. While any manner for constructing the VDC plate 840 may be suitable for use with the embodiments of the antenna, as a shorthand in the specific embodiments the VDC plate 840 is shown consisting of upper binder 842, (e.g., glass, PET, etc.) variable dielectric constant material 844 (e.g., twisted nematic liquid crystal layer), and bottom binder 846. In other embodiments one or both of the binder layers 842 and 844 may be omitted. Alternatively, adhesive such as epoxy or glass beads may be used instead of the binder layers 842 and/or 844.

In some embodiments, e.g., when using twisted nematic liquid crystal layer, the VDC plate 840 also includes an alignment layer that may be deposited and/or glued or be formed on the upper binder 342. The alignment layer may be a thin layer of material, such as polyimide-based PVA, that is being rubbed or cured with UV in order to align the molecules of the LC at the edges of confining substrates.

The effective dielectric constant of VDC plate 840 can be controlled by applying DC potential across the VDC plate 840. For that purpose, electrodes may be formed and connected to controllable voltage potential. There are various arrangements to form the electrodes, and several examples are disclosed in the above-cited patents. In the arrangement shown in FIG. 8, electrodes 847 is provided on the top surface of the bottom binder 846. As one example, electrode 847 is shown connected to controller Ctl. Alternatively, the DC potential may be applied directly to the variable delay lines 820 and 822. Thus, by changing the DC voltage, one can change the dielectric constant of the VDC material in the vicinity of the electrodes or variable delay lines, and thereby change the phase of an RF signal traveling over the variable delay lines. The controller, Ctl, runs software that causes the controller to output the appropriate control signal to set the appropriate output voltage of variable potential power supplier. Thus, the antenna's performance and characteristics can be controlled using software—hence software controlled antenna.

At this point it should be clarified that in the subject description the use of the term ground refers to both the generally acceptable ground potential, i.e., earth potential, and also to a common or reference potential, which may be a set potential or a floating potential. Similarly, while in the drawings the symbol for ground is used, it is used as shorthand to signify either an earth or a common potential, interchangeably. Thus, whenever the term ground is used herein, the term common or reference potential, which may be set or floating potential, is included therein. Also, at times the subject disclosure utilizes the terms delay line or phase shifter interchangeably, as a delay line generates a phase shift in the signal traveling thereon.

As with all RF antennas, reception and transmission are symmetrical, such that a description of one equally applies to the other. In this description it may be easier to explain transmission, but reception would be the same, just in the opposite direction.

In transmission mode the RF signal is applied to the feed patch 860 via connector 865 (e.g., a coaxial cable connector). As shown in FIG. 8, in this particular example there is no electrical DC connection between the feed patch 860 and the corporate feed port CF. However, in this embodiment the layers are designed such that an RF short is provided between the feed patch 860 and port CF. As illustrated in FIG. 8, a back plane conductive ground (or common) 855 is formed on the top surface of back plane insulator (or dielectric) 850 or the bottom surface of bottom binder 846. The back plane conductive ground 855 is generally a layer of conductor covering the entire area of the antenna array. At each RF feed location a window (DC break) 853 is provided in the back plane conductive ground 855. The RF signal travels from the feed patch 860, via the window 853, and is coupled to the port CF. The reverse happens during reception. Thus, a DC open and an RF short are formed between port CF and feed patch 860.

In one example the back plane insulator 850 is made of a Rogers® (FR-4 printed circuit board) and the feed patch 860 may be a conductive line formed on the Rogers. Rather than using Rogers, a PTFE (Polytetrafluoroethylene or Teflon®) or other low loss material may be used.

Thus, generally the embodiment of FIG. 8 may be characterized as a multi-layer antenna array, comprising: a radiation layer comprising a plurality of radiating patches arranged in an array; a phase shift layer comprising a plurality of variable phase shifters arranged in sub-groups, each subgroup having at least two variable phase shifters; a ground plane layer comprising a conductive plate maintaining a common potential; an RF signal distribution layer comprising a plurality of RF conductors; and a switch having multiple throws connected to the plurality of variable phase shifters and a pole connected to the plurality of RF conductors. The phase shift layer includes a variable phase shift layer incorporating the plurality of variable phase shifters, and a fixed phase bias layer comprising a plurality of fixed phase shifters, each connected to one of the variable phase shifters. The switch may be a plurality of multi-throw switches arranged within the variable phase shift layer, each having multiple throws connected to the variable phase shifters within one of the subgroups. The variable dielectric constant (VDC) layer is in contact with the phase shift layer, more specifically, in contact with the variable phase shift layer.

By the embodiments disclosed above, an array antenna is provided, comprising: a variable dielectric constant (VDC) plate; a plurality of radiating patches provided in an array over the VDC plate; a plurality of variable delay lines provided over the VDC plate and below the radiating patches; a plurality of fixed delay lines provided over the VDC plate and below the radiating patches, each fixed delay line connected to one of the variable delay lines; a corporate feed having a plurality of ports; a ground plane; and a plurality of switches configured to selectively connect each of the ports to a selected variable delay line and to selectively connect each of the radiating patches to a selected fixed delay line. The antenna may have m fixed delay line, wherein n of the fixed delay lines introduce zero delay, and wherein n<m. The antenna may have m variable delay lines and n fixed delay lines, wherein n<m. Each of the switches may have one port and at least two throws. In the antenna, the variable delay lines may be provided on one layer and the fixed delay lines may be provided on a second layer above the first layer. Alternatively, the variable delay lines and the fixed delay lines may be provided on the same layer.

It should be understood that processes and techniques described herein are not inherently related to any particular apparatus and may be implemented by any suitable combination of components. Further, various types of general purpose devices may be used in accordance with the teachings described herein. The present invention has been described in relation to particular examples, which are intended in all respects to be illustrative rather than restrictive. Those skilled in the art will appreciate that many different combinations will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. An antenna, comprising:
a plurality of radiators arranged in an array;
a plurality of transmission lines, each coupled to one of the radiators;
a plurality of variable phase shifters divided into a plurality of subgroups, each of the subgroups interposed between one of the transmission lines and one of the radiators;
a controller outputting a signal indicative of amount of phase shift to be activated for each of the radiators;
a switch interposed between the transmission lines and the plurality of variable phase shifters, the switch receiving the signal from the controller and connecting selected variable phase shifters to selected transmission lines according to the signal.

2. The antenna of claim 1, wherein each of the variable phase shifters introduces a phase shift of less than 360°.

3. The antenna of claim 1, wherein each of the variable phase shifters introduces a phase shift up to 360°/x, wherein x is a natural number of 2 or larger.

4. The antenna of claim 1, wherein each of the plurality of subgroups of variable phase shifters includes n variable phase shifters, and wherein each variable phase shifter within the group introduces a phase shift of up to 360°/n.

5. The antenna of claim 4, further comprising a plurality of fixed phase shifters, and wherein at least one of the variable phase shifters within each group is connected to one of the fixed phase shifters.

6. The antenna of claim 1, wherein each of the plurality of subgroups of variable phase shifters includes n variable phase shifters, and wherein each variable phase shifter within the group introduces a phase shift of up to (360°/n)+m, wherein m<(360°/n).

7. The antenna of claim 6, further comprising a plurality of fixed phase shifters, and wherein at least one of the variable phase shifters within each group is connected to one of the fixed phase shifters.

8. The antenna of claim 1, wherein the controller further output a potential signal indicative of the amount of electrical potential corresponding to the amount of phase shift to be activated for each of the radiators.

9. A multi-layer antenna array, comprising:
a radiation layer comprising a plurality of radiating patches arranged in an array;
a phase shift layer comprising a plurality of variable phase shifters arranged in sub-groups, each subgroup having at least two variable phase shifters;
a ground plane layer comprising a conductive plate maintaining a common potential;
an RF signal distribution layer comprising a plurality of RF conductors;
a switch having multiple throws connected to the plurality of variable phase shifters and a pole connected to the plurality of RF conductors.

10. The antenna of claim 9, wherein the phase shift layer comprises a variable phase shift layer incorporating the plurality of variable phase shifters, and a fixed phase bias layer comprising a plurality of fixed phase shifters, each connected to one of the variable phase shifters.

11. The antenna of claim 10, wherein the switch comprises a plurality of multi-throw switches arranged within the variable phase shift layer, each having multiple throws connected to the variable phase shifters within one of the subgroups.

12. The antenna of claim 9, further comprising a variable dielectric constant (VDC) layer in contact with the phase shift layer.

13. The antenna of claim 10, further comprising a variable dielectric constant (VDC) layer in contact with the variable phase shift layer.

14. The antenna of claim 11, wherein the switch further comprises a plurality of multi-throw switches arranged within the fixed phase bias layer, each having multiple throws connected to a group of the fixed phase shifters and a pole coupled to one of the plurality of radiating patches.

15. The antenna of claim 10, wherein the plurality of fixed phase shifters comprises a plurality of signal lines of different lengths.

16. The antenna of claim 10, wherein the plurality of fixed phase shifters are arranged in groups, wherein in each group one fixed phase shifter introduces a phase shift of zero degrees and a second f phase shifter introduces a phase shift of 180°.

17. The antenna of claim 10, further comprising a plurality of vias, each via having one end connected to one of the variable phase shifters and another end connected to one of the fixed phase shifters.

18. An array antenna, comprising:
a variable dielectric constant (VDC) plate;
a plurality of radiating patches provided in an array over the VDC plate;
a plurality of variable delay lines provided over the VDC plate and below the radiating patches;
a plurality of fixed delay lines provided over the VDC plate and below the radiating patches, each fixed delay line connected to one of the variable delay lines;
a corporate feed having a plurality of ports; a ground plane; and
a plurality of switches configured to selectively connect each of the ports to a selected variable delay line and to selectively connect each of the radiating patches to a selected fixed delay line.

19. The antenna of claim 18, wherein the plurality of fixed delay lines comprises m fixed delay line, and wherein n of the fixed delay lines introduce zero delay, and wherein n<m.

20. The antenna of claim 18, wherein the plurality of variable delay lines comprises m variable delay lines, and the plurality of fixed delay line comprises n fixed delay lines, and wherein n<m.
